(19) United States
(12) Patent Application Publication
(10) Pub. No.: US 2013/0194524 A1
(43) Pub. Date: Aug. 1, 2013

(54) DISPLAY PANEL AND DISPLAY DEVICE PROVIDED WITH SAME

(71) Applicants: Yuichi Kita, Osaka-shi (JP); Katsuhiro Kikuchi, Osaka-shi (JP); Takashi Ochi, Osaka-shi (JP); Masakazu Shibasaki, Osaka-shi (JP); Iori Aoyama, Osaka-shi (JP); Sayuri Fujiwara, Osaka-shi (JP); Eiji Satoh, Osaka-shi (JP); Yasushi Asaoka, Osaka-shi (JP); Kazuhiro Deguchi, Osaka-shi (JP)

(72) Inventors: Yuichi Kita, Osaka-shi (JP); Katsuhiro Kikuchi, Osaka-shi (JP); Takashi Ochi, Osaka-shi (JP); Masakazu Shibasaki, Osaka-shi (JP); Iori Aoyama, Osaka-shi (JP); Sayuri Fujiwara, Osaka-shi (JP); Eiji Satoh, Osaka-shi (JP); Yasushi Asaoka, Osaka-shi (JP); Kazuhiro Deguchi, Osaka-shi (JP)

(73) Assignee: SHARP KABUSHIKI KAISHA, Osaka-shi, Osaka (JP)

(21) Appl. No.: 13/824,632

(22) PCT Filed: Oct. 4, 2011
(86) PCT No.: PCT/JP2011/072866

§ 371 Date: Mar. 18, 2013

(30) Foreign Application Priority Data
Oct. 5, 2010 (JP) 2010-225535

(51) Int. Cl. G02F 1/1335

(52) U.S. Cl. CPC G02F 1/133504
USPC 349/41

(57) ABSTRACT

A liquid crystal panel includes a liquid crystal layer that can switch to a light transmitting state and a light scattering state, and lines provided on a portion of the liquid crystal layer on the side opposite to the observation side. The lines are provided with a reflecting portion by which at least a portion of light that entered from the observation side is reflected toward the observation side.

### TECHNICAL FIELD

The present invention relates to a display panel configured so as to be able to switch between a light transmitting state and a light scattering state.

### BACKGROUND ART

There is a conventionally-known display panel configured so as to be able to switch between a light transmitting state and a light scattering state. As disclosed in JP H5-191726A for example, with such a display panel, only a region on a screen that is to be irradiated with projection light from a projector is put in an opaque state, and other portions are put in a transparent state. An image projected on the display panel thus appears to be a real image.

### DISCLOSURE OF INVENTION

Incidentally, with a configuration that can switch between a light transmitting state and a light scattering state such as that disclosed in JP H5-191726A, when light is irradiated from the observation side, backward scattering is weak, and almost all of the light is forward scattered. The display performance of the display device greatly decreases for this reason.

An object of the present invention is to, for a display panel that can switch between a light transmitting state and a light scattering state, obtain a configuration in which a sense of transparency is obtained when a liquid crystal layer is in the light transmitting state, and in which it is possible to suppress a decrease in display performance when light is irradiated from the observation side.

A display panel according to an embodiment of the present invention includes: a liquid crystal layer that can switch to a light transmitting state and a light scattering state; a metal layer provided in a portion of the liquid crystal layer on a side opposite to an observation side; and a line at least partially configured by the metal layer, wherein the line is provided with a reflecting portion by which at least a portion of light that entered from the observation side is reflected toward the observation side.

With the display panel according to this embodiment of the present invention, a sense of transparency is obtained when the liquid crystal layer is in the light transmitting state, and it is possible to suppress a decrease in display performance when light is irradiated from the observation side.

### BRIEF DESCRIPTION OF DRAWINGS

FIG. 1 is a diagram showing an overall configuration of a display device that includes a liquid crystal panel, according to a first embodiment.

FIG. 2 is a diagram showing a schematic configuration of the liquid crystal panel and driving circuits for driving the liquid crystal panel.

FIG. 3 is a plan view showing a metal portion in a pixel.

FIG. 4 is a cross-sectional view taken along line IV-IV in FIG. 3.

FIG. 5 is a diagram schematically showing how the reflectivity of the liquid crystal panel is measured.

FIG. 6 is a graph showing the relationships that reflectivity and transmissivity have with the percentage of an aperture portion that is occupied by a reflecting portion.

FIG. 7 is a cross-sectional diagram showing a schematic configuration of a liquid crystal panel according to a second embodiment.

FIG. 8 is an enlarged plan view of a cutout portion of the liquid crystal panel.

FIG. 9 is a cross-sectional diagram showing a schematic configuration of a liquid crystal panel according to a third embodiment.

### DESCRIPTION OF THE INVENTION

A display panel according to an embodiment of the present invention includes: a liquid crystal layer that can switch to a light transmitting state and a light scattering state; a metal layer provided in a portion of the liquid crystal layer on a side opposite to an observation side; and a line at least partially configured by the metal layer, wherein the line is provided with a reflecting portion by which at least a portion of light that entered from the observation side is reflected toward the observation side (first configuration).

According to this configuration, light that has entered from the observation side is reflected by the reflecting portion. Moreover, the light reflected by the reflecting portion can be diffused by causing the liquid crystal layer in the portion where the light enters to enter the light scattering state. This enables efficiently obtaining the backward scattering of light that entered from the observation side, thus improving the display performance.

Also, by providing the metal layer in only portions, a sense of transparency can be obtained for the display panel when the liquid crystal layer is put in the light transmitting state. Moreover, when the liquid crystal layer is in the light transmitting state, the light that enters from the observation side of the reflective display panel passes through the display panel with almost no reflection by the reflecting portion. Accordingly, brighter reflected light is obtained when the liquid crystal layer is in the light scattering state than when it is in the light transmitting state, and thus a black state is achieved when the liquid crystal layer is in the light transmitting state. Accordingly, although the black and white states tend to switch depending on the viewing direction if the metal layer is provided on the entire face, when the metal layer is provided in only portions as described above, it is possible to prevent the switching of the black and white states depending on the viewing direction, and the viewing angle can be made wider.

Furthermore, the above-described configuration enables configuring the reflecting portion using a line, without separately providing a metal layer.

In the first configuration, it is preferable that a light-shielding layer that blocks external light is further included, wherein the reflecting portion has an area that, per pixel, is in a range of 15% to 50%, inclusive, of the area of a portion other than the light-shielding layer (second configuration). According to this configuration, when light enters from the observation side of the display panel, a light transmitting state having a high sense of transparency is obtained, and display performance is also improved when projecting an image on the reflecting portion.

In the first or second configuration, it is preferable that a pair of transparent electrodes provided so as to sandwich the liquid crystal layer on respective sides of the liquid crystal layer is further included, wherein a cutout portion in which the transparent electrode is not formed is provided in correspondence with the reflecting portion in at least one of the pair of transparent electrodes (third configuration).

According to this configuration, the liquid crystal layer is always in the scattering state in the cutout portion in which the transparent electrode is not formed, and thus light that undergoes regular reflection due to the reflecting portion is diffused by the liquid crystal layer in the scattering state. This makes it possible to prevent reflections from appearing on the metal layer when the light transmitting state is achieved in the portions of the liquid crystal layer in which the transparent electrodes are formed.

In particular, in the third configuration, it is preferable that the cutout portion is provided so as to be located within the reflecting portion when viewed from the observation side (fourth configuration). If the cutout portion in the transparent electrode, that is to say the region that is always in the light scattering state, is larger than the reflecting portion, the transmissivity decreases. If the cutout portion is made smaller than the reflecting portion when viewed from the observation side as described above in response to this, a reduction in the transmissivity can be prevented, and a high sense of transparency can be obtained.

In any one of the first to fourth configurations, it is preferable that a switching element provided on the side of the liquid crystal layer opposite to the observation side is further included, wherein the switching element is composed of a material that can transmit light in a visible range and does not produce stand-by consumption current due to light in the visible range (fifth configuration).

This configuration eliminates the need to provide a light-shielding member on the observation side of the switching element in order to reduce the stand-by consumption current (off-state leakage current) of the switching element. In other words, the switching element transmits light in the visible range and does not produce stand-by consumption current due to light in the visible range. This enables reducing the stand-by consumption current of the switching element without providing a light-shielding member. Moreover, the transmissivity is improved since the switching element transmits visible light. Note that light that causes a switching element to produce stand-by consumption current is generally in substantially the same wavelength range as the wavelength range that damages the liquid crystal layer, and therefore light in that wavelength range is removed by a cutoff filter or the like.

Also, since a light-shielding member is not necessary, the transmissivity of the transmitting portion can be improved, and the reflectivity of the reflecting portion can be improved. Furthermore, since there is no need to provide a light-shielding member, the manufacturing cost for the display panel is reduced by a commensurate amount.

In the fifth configuration, it is preferable that the liquid crystal layer contains polymer network liquid crystal (sixth configuration). If the liquid crystal layer contains PNLC (Polymer Network Liquid Crystal) in this way, UV irradiation needs to be performed in the process of forming the polymer network. If a light-shielding member is present at this time, portions that are not reached by UV light appear due to the light-shielding member, and variation in the polymer diameter rises. As a result, the degree of scattering decreases in portions where the polymer diameter is high. By achieving a configuration that does not require a light-shielding member as with the above-described fifth configuration in response to this, it is possible to suppress variation in the polymer diameter and prevent a decrease in the degree of scattering.

In the fifth or sixth configuration, it is preferable that the switching element is configured by an indium-gallium-zinc composite oxide (seventh configuration). According to this configuration, it is possible to realize a switching element that transmits light in the visible range and does not produce stand-by consumption current due to light in the visible range, and it is possible to obtain the effects of the above-described fifth configuration.

In any one of the first to seventh configurations, it is preferable that a black matrix layer that defines a pixel aperture portion is further included, wherein the reflecting portion is configured by a portion of the line that is not covered by the black matrix layer (eighth configuration). According to this configuration, a black matrix layer is not provided in a configuration likewise to that of conventional technology, thus making it possible to easily configure the reflecting portion.

In any one of the first to eighth configurations, it is preferable that a reflection prevention film provided on a surface on at least one of the observation side and a back face side is further included (ninth configuration).

This enables preventing the reflection of light that enters the display panel, thus making it possible to improve the light transmissivity of the display panel. Accordingly, the visibility of the display panel when viewed from the observation side can be improved.

Back face side as used herein refers to the side of the display panel opposite to the observation side.

A display device according to an embodiment of the present invention includes: the display panel according to any one of claims 1 to 9; and a projection device that irradiates the display panel with light from the observation side (tenth configuration).

Hereinafter, preferred embodiments of a semiconductor device of the present invention will be described with reference to the drawings. Note that regarding the dimensions of the constituent members in the drawings, the dimensions of the actual constituent members, the ratios of the dimensions of the constituent members, and the like are not shown faithfully.

### FIRST EMBODIMENT

Overall Configuration

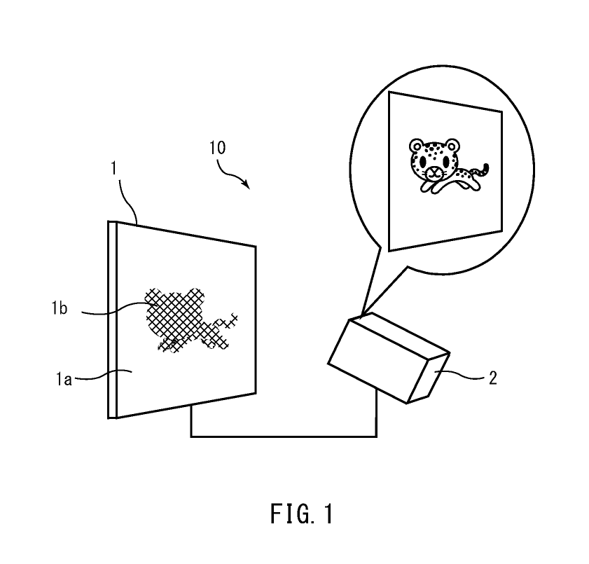

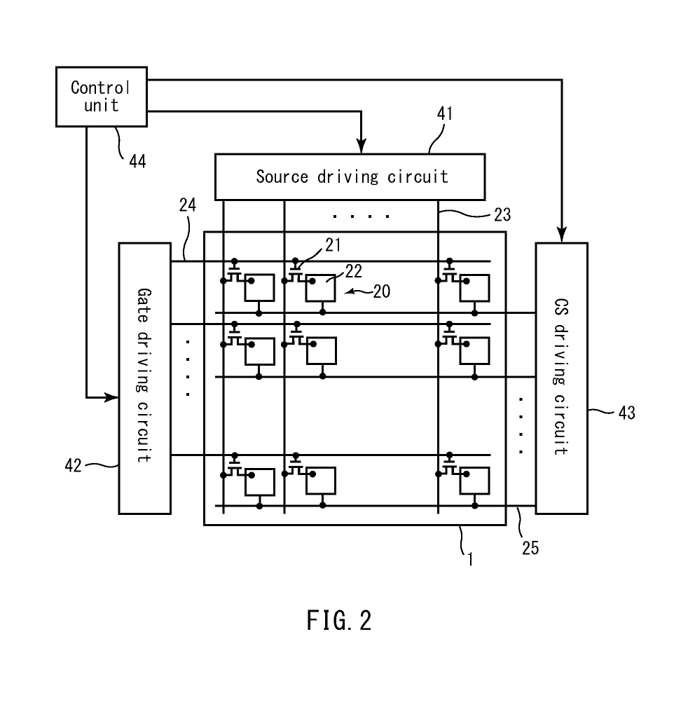

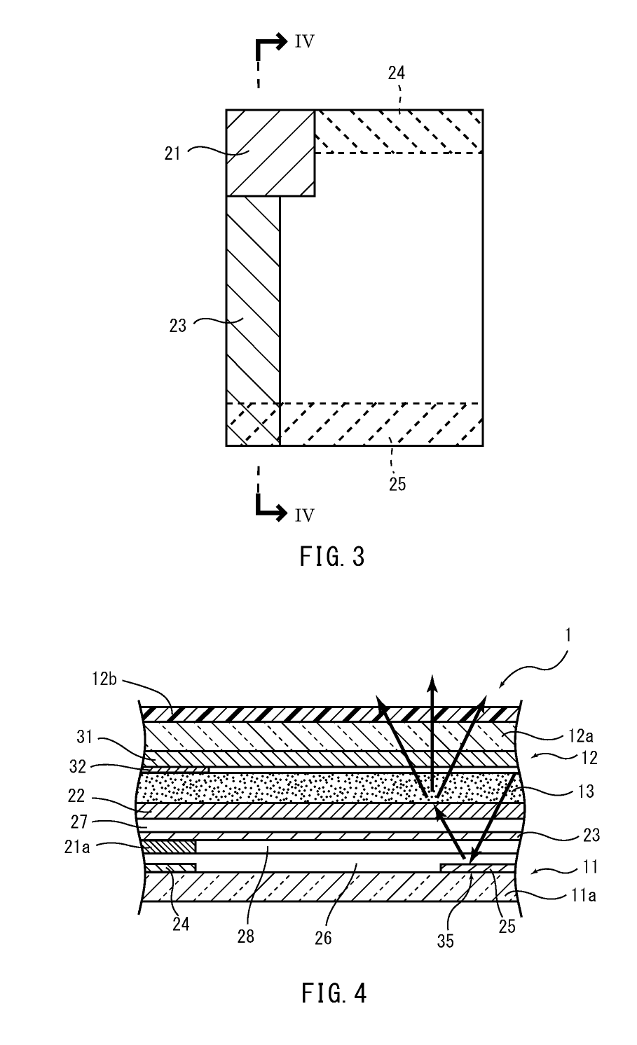

FIG. 1 shows the schematic configuration of a display device that displays images on a liquid crystal panel 1 (display panel) with a projector 2, according to an embodiment of the present invention. FIG. 2 schematically shows the circuit configuration of the liquid crystal panel 1 and driving circuits for driving the liquid crystal panel 1. FIG. 3 shows the arrangement of lines in one pixel of the liquid crystal panel 1. FIG. 4 shows the schematic configuration of the liquid crystal panel 1 in a cross-sectional view. As shown in FIG. 1, the display device of the present embodiment is configured so as to display color images and the like by using the projector 2 to project images onto a scattering portion displayed on the liquid crystal panel 1.

The liquid crystal panel 1 has multiple pixels 20 arranged in a matrix. As shown in FIG. 2, source lines 23, gate lines 24, and CS lines 25 are connected to the pixels 20 of the liquid crystal panel 1. The source lines 23 are connected to a source driving circuit 41, and supply later-described TFTs 21 in the pixels 20 with signals output from the source driving circuit 41. The gate lines 24 are connected to a gate driving circuit 42 and supply the TFTs 21 in the pixels 20 with signals output from the gate driving circuit 42. The CS lines 25 are connected to later-described auxiliary capacitors, and supply the auxiliary capacitors with signals from a CS driving circuit 43. The source driving circuit 41, the gate driving circuit 42, and the CS driving circuit 43 are connected to a control unit 44, and are configured so as to output signals to the source lines 23, the gate lines 24, and the CS lines 25 in accordance with signals output from the control unit 44. The source lines 23, the gate lines 24, and the CS lines 25 therefore configure signal lines.

The following is a detailed description of the structure of the liquid crystal panel 1.

As shown in FIG. 3, the TFTs 21, the source lines 23, the gate lines 24, and the CS lines 25 are connected to the pixels 20 of the liquid crystal panel 1. Although not particularly shown, a later-described black matrix 32 is provided so as to cover portions of the TFTs 21 and the gate lines 24. Here, the source lines 23, the gate lines 24, and the CS lines 25 are configured by a metal material as will be described later, and configure a metal layer.

As shown in the schematic cross-sectional structure in FIG. 4, the liquid crystal panel 1 includes an active matrix substrate 11 on which many pixels are arranged in a matrix, and a counter substrate 12 arranged so as to oppose the active matrix substrate 11. Also, a liquid crystal layer 13 that can switch to a light scattering state and a light transmitting state is provided between the active matrix substrate 11 and the counter substrate 12 of the liquid crystal panel 1.

The liquid crystal layer 13 is composed of PNLC (Polymer Network Liquid Crystal), which includes macromolecules formed in a network and liquid crystal molecules between two plastic films. This liquid crystal layer 13 has the characteristic of switching to a light transmitting state and a light scattering state depending on whether or not an electric field is applied. For example, in the liquid crystal panel 1, the liquid crystal layer 13 scatters light when an electric field is not applied. On the other hand, the liquid crystal layer 13 enters the transparent state in which it transmits light when an electric field is applied. Note that PDLC (Polymer Dispersed Liquid Crystal) may be used for the liquid crystal layer 13.

The active matrix substrate 11 includes a transparent substrate 11a such as a glass substrate on which the TFTs (Thin Film Transistors) 21, pixel electrodes 22, lines (e.g., the source lines 23, the gate lines 24, and the CS lines 25), and the like are provided. The pixel electrodes are transparent electrodes, as will be described later. The lines 23 to 25 are configured by an aluminum alloy, and reflection occurs at their surfaces. Note that reference sign 21a in FIG. 4 denotes the semiconductor layer of the TFT 21. This semiconductor layer is formed by doping a silicon film 28 with an impurity. The configuration of the TFTs will not be described since it is the same as that in conventional technology.

The pixel electrodes 22 are transparent electrodes, and are formed from a conductive material that has light-transmitting characteristics such as ITO (Indium Tin Oxide). The pixel electrodes 22 are arranged in the pixels so as to be separated from each other. The pixel electrodes 22 define the pixels, which serve as one unit of image display.

Source electrodes, gate electrodes, and drain electrodes in the TFTs 21 are respectively connected to the source lines 23, the gate lines 24, and the pixel electrodes 22. Signals are input to the TFTs 21 via the gate lines 24 and the source lines 23, and the driving of the TFTs 21 will not be described in detail since it is the same as in conventional display devices.

Although not particularly shown, pixel capacitors and auxiliary capacitors are connected to the drain side of the TFTs 21. The auxiliary capacitor is provided in parallel to the pixel capacitor, and functions so as to suppress variation in the potential of the pixel capacitor due to liquid crystal leakage current or the like. The CS lines 25 are connected to the auxiliary capacitors.

Also, a first insulating layer 26 is provided between the TFTs 21 and the gate lines 24 and CS lines 25 in the active matrix substrate 11. A second insulating layer 27 is provided on the first insulating layer 26 and the TFTs 21. Note that the first insulating layer 26 and the second insulating layer 27 are not indicated by hatching in FIG. 4.

The counter substrate 12 includes a transparent substrate 12a such as a glass substrate on which, for example, a common electrode 31 (transparent electrode) composed of a transparent conductive film (ITO or the like) or the like is provided. The black matrix 32 (black matrix layer) for covering portions of the TFTs 21 and the gate lines 24 is provided on the common electrode 31 of the counter substrate 12. This black matrix 32 is normally formed in the same layer as the color filter layer. The portions not covered by the black matrix 32 are pixel aperture portions. In the present embodiment, the black matrix 32 covers portions of the TFTs 21 and the gate lines 24, but does not cover the source lines 23, the CS lines 25, or portions of the gate lines 24. In other words, the source lines 23, the CS lines 25, and the portions of the gate lines 24 that are not covered by the black matrix 32 configure a reflecting portion 35 that reflects light on the observation side.

Also, a reflection prevention film 12b for preventing surface reflection is provided on the observation side of the counter substrate 12, that is to say, the observation side of the transparent substrate 12a. Providing the reflection prevention film 12b allows preventing a decrease in visibility due to the reflection of light at the surface on the observation side of the liquid crystal panel 1. Note that although the reflection prevention film 12b is provided in the present embodiment, a configuration is possible in which the reflection prevention film 12b is not provided.

Furthermore, the reflection prevention film may be provided on the side (back face side) of the active matrix substrate 11 that is opposite to the observation side, that is to say, the back face side of the transparent substrate 11a. This allows preventing light that enters the liquid crystal panel 1 from the back face side from being reflected by the transparent substrate 11a of the active matrix substrate 11. Accordingly, since the light that enters the liquid crystal panel 1 from the back face side is transmitted, it is possible to prevent a decrease in the appearance of the background of the liquid crystal panel 1 when viewed from the observation side.

With the liquid crystal panel 1 having the above-described configuration, the liquid crystal layer 13 can be switched to the light transmitting state and the light scattering state in units of pixels by controlling the electric field that is applied to the liquid crystal layer 13, that is to say, the voltage that is applied between the common electrode 31 and the pixel electrodes 22. Specifically, by controlling the application of the electric field to the liquid crystal layer 13 with the TFTs 21, a transparent portion la that is a light transmitting region and a scattering portion 1b that is a light scattering region are selectively formed in the liquid crystal panel 1 (see FIG. 1).

Reflecting Portion

With the liquid crystal panel 1 having the above-described configuration, when the liquid crystal layer 13 is in the light transmitting state, the portions other than the portions that do not transmit light (e.g., the portions where the TFTs 21 and the lines 23 to 25 are provided, and the portions covered by the black matrix 32) are in the transparent state. For this reason, the side opposite to the observation side is visible through the liquid crystal panel 1. Also, as previously described, in the present embodiment, portions of the TFTs 21 and the gate lines 24 are covered by the black matrix 32, and the other lines and the like are not covered by the black matrix 32.

Accordingly, portions that are covered by the black matrix 32, a transmitting portion that transmits light when the liquid crystal layer 13 is in the light transmitting state, and the reflecting portion 35 that reflects light entering from the observation side are formed in the liquid crystal panel 1 when viewed from the observation side. As previously described, the reflecting portion 35 is configured by the source lines 23, the CS lines 25, and the portions of the gate lines 24 that are not covered by the black matrix 32.

By configuring the reflecting portion 35 using portions of lines in this way, light that is reflected by the reflecting portion 35 can be effectively diffused when the liquid crystal layer 13 is in the light scattering state, as shown by the bold arrows in FIG. 4. Accordingly, whereas almost all of the light is forward scattered in a liquid crystal panel that does not have the reflecting portion 35, with the configuration of the present embodiment, most of the light can be backward scattered, thus improving the display performance of the display device.

Moreover, since lines are used as the reflecting portion 35 in the configuration of the present embodiment, the viewing angle can be made wider than that of, for example, reflective liquid crystal panels whose entire face is provided with a reflector. Specifically, in the case where a reflector is provided on the entire face, the light scattering state corresponds to black in the regular reflection direction since the liquid crystal layer is brighter in the light transmitting state than in the light scattering state, and the light transmitting state corresponds to black in the other reflection direction since the liquid crystal layer is brighter in the light scattering state. In other words, with a reflective liquid crystal panel whose entire face is provided with a reflector, a phenomenon occurs in which the black and white states switch between the regular reflection direction and the other direction. In contrast, when the reflecting portion 35 is provided in portions as in the present embodiment, the liquid crystal layer 13 enters the black state in the light transmitting state since it transmits light, and enters the white state in the light scattering state since a bright state is achieved due to the reflection of light by the liquid crystal layer 13 and the reflecting portion 35. In other words, with the configuration of the present embodiment, the same display image can be seen regardless of the direction from which it is viewed, and the viewing angle can be made wider.

Also, with the configuration of the present embodiment, UV irradiation needs to performed from the counter substrate 12 side (observation side) when forming the liquid crystal layer 13 composed of PNLC. Specifically, a mixture obtained by mixing liquid crystal, a macromolecule matrix, and the like is sandwiched between the active matrix substrate 11 and the counter substrate 12, and the liquid crystal layer 13 is formed by irradiating the mixture with ultraviolet light from the counter substrate 3 side. In this configuration, the portions that are not irradiated with ultraviolet light due to the black matrix 32 can be made smaller by minimizing the size of the portions that are covered by the black matrix 32 as described above. This allows irradiating a greater range of the mixture with ultraviolet light.

Incidentally, if the mixture is not sufficiently irradiated with ultraviolet light, the polymer diameter will increase, and the droplets of liquid crystal that are dispersed in the macromolecule matrix become very large. As a result, the degree of scattering of the liquid crystal decreases in the portions where droplets are very large, thus causing a decrease in display quality.

In contrast, polymers having more uniform diameters can be formed by reducing the size of the black matrix 32 and sufficiently irradiating the mixture with ultraviolet light as described above. This allows suppressing the formation of very large droplets in the liquid crystal layer 13, thus improving the display quality of the liquid crystal panel 1.

In order to confirm effects of the configuration of the present embodiment, a see-through panel was actually created, and the relationships that the size of the reflecting portion has with reflectivity and transmissivity were obtained. Note that the created see-through panel had a size of 60 inches and a cell thickness of 6 μm. Also, since the created see-through panel entered the light transmitting state when an electric field was applied to the liquid crystal layer, the reflectivity was measured when an electric field was not applied to the liquid crystal layer, and the transmissivity was measured when an electric field was applied to the liquid crystal layer.

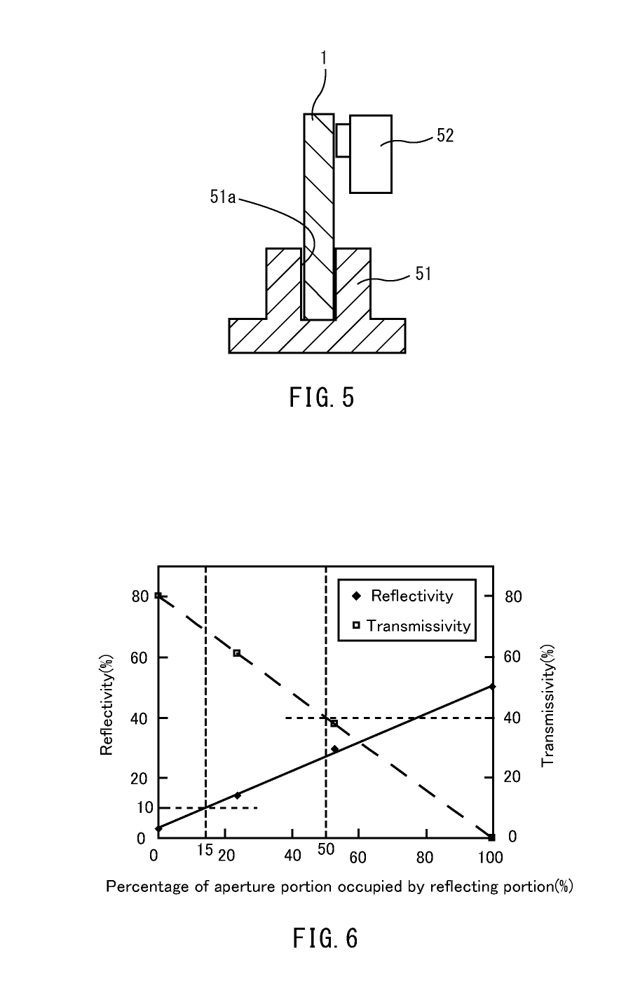

In the present embodiment, the reflectivity is measured by receiving reflected light in the 8-degree direction using diffuse illumination. At this time, regular reflection light is eliminated. Specifically, in the present embodiment, the reflectivity was measured using a reflectivity measuring device (CM2600d) manufactured by Konica Minolta, Inc. Also, as shown in FIG. 5, a support base 51 having a groove portion 51a capable of supporting the liquid crystal panel 1 (see-through panel) was used when measuring the reflectivity. Specifically, the reflectivity was measured by the reflectivity measuring device 52 from the counter substrate 12 side (observation side) of the liquid crystal panel 1 while the liquid crystal panel 1 was stood upright in the groove portion 51a of the support base 51. Accordingly, the reflectivity was measured while nothing was on the active matrix substrate 11 side of the liquid crystal panel 1.

Also, the transmissivity was measured using a device that includes a light emitting portion and a light receiving portion that receives parallel light emitted from the light emitting portion. Specifically, an LCD evaluating device (LCD5200) manufactured by Otsuka Electronics Co., Ltd. was used. More specifically, in the present embodiment, parallel light emitted from the light emitting portion was received in the case of not striking the liquid crystal panel and the case of striking the liquid crystal panel, and the transmissivity was obtained by obtaining the ratio of the intensity of light in the two cases. Note that when the liquid crystal panel was irradiated with parallel light, the liquid crystal panel was fixed in the support base as shown in FIG. 5, similarly to the above-described measurement of reflectivity.

FIG. 6 shows the results of measuring the reflectivity and the transmissivity. As shown in FIG. 6, as the percentage of the aperture portion (the portion not covered by the black matrix in a pixel) occupied by the reflecting portion (the portion not covered by the black matrix in the metal portions such as the lines) increases, the reflectivity increases and the transmissivity decreases. When the reflecting portion does not exist, the reflectivity was the very low value of approximately 3%, and the transmissivity was approximately 80%. The transmissivity was not 100% because of light that is not transmitted due to reflection at the surface of the liquid crystal panel 1.

A reflectivity y1 and a transmissivity y2 can be obtained from the results shown in FIG. 6 using the following relational expressions. Specifically, the solid line (reflectivity) and the dashed line (transmissivity) in FIG. 6 are represented by the following expressions.

y1=0.47x+0.03

y2=−0.8x+0.8

Here, x in the above expressions is the percentage of the aperture portion occupied by the reflecting portion.

Incidentally, the reflectivity of a reflective liquid crystal panel is approximately 10%, and the transmissivity is 40% in the case where the opposite side of the liquid crystal panel does not extend beyond the panel and appears transparent in a natural fashion. For this reason, in order to obtain a light transmitting state with a high sense of transparency without reducing image display quality, it is preferable that the reflectivity is 10% or higher, and the transmissivity is 40% or lower. In FIG. 5, the percentage of the aperture portion occupied by the reflecting portion is in the range of 15% to 50% such that the reflectivity is 10% or higher and the transmissivity is 40% or lower. Accordingly, it is preferable that the percentage of the aperture portion occupied by the reflecting portion is in the range of 15% to 50%.

Note that in FIG. 5, when the percentage of the aperture portion occupied by the reflecting portion is approximately 24% for example, the aperture ratio of the transmitting portion per pixel is 65%, and the areas of the reflecting portion and the black matrix are respectively 20% and 15% of the area of one pixel.

Also, the area of the reflecting portion may be adjusted by changing the area covered by the black matrix, or may be adjusted by changing the area of the metal portions such as the exposed lines. Note that as previously described, it is preferable that the percentage of the aperture portion occupied by the reflecting portion is in the range of 15% to 50%.

### EFFECTS OF FIRST EMBODIMENT

In this embodiment, portions of metal portions such as lines are not covered by the black matrix 32, and therefore those portions function as the reflecting portion 35 so as to reflect light irradiated from the observation side. Accordingly, if the liquid crystal layer 13 is put into the light scattering state, and light is irradiated on the reflecting portion 35 by the projector 2 from the observation side, an image can be displayed on the liquid crystal panel 1. On the other hand, light is transmitted in the portions in which the liquid crystal layer 13 is in the light transmitting state, and thus the opposite side of the liquid crystal panel 1 is visible through the liquid crystal panel 1. This enables obtaining an effect in which images displayed on the liquid crystal panel 1 appear to float in the air.

Also, since the reflecting portion 35 is provided in only portions of the side opposite to the observation side of the liquid crystal panel 1, the liquid crystal panel 1 transmits light and is in the black state in the portions in which the liquid crystal layer 13 is in the light transmitting state, and the liquid crystal panel 1 is white in the portions in which the liquid crystal layer 13 is in the light scattering state. Since these black and white states do not change depending on the viewing angle as in a configuration in which a reflecting member is provided on the entire face, the viewing angle of the liquid crystal panel 1 can be made wider, thus improving the display quality of the liquid crystal panel 1.

Moreover, by reducing the size of the black matrix 32 as described above, when forming the liquid crystal layer 13 composed of PNLC, the mixture obtained by mixing a macromolecular polymer, liquid crystal, and the like can be sufficiently irradiated with ultraviolet light, and the formation of very large droplets can be suppressed. This improves the display quality of the liquid crystal panel 1.

Also, by setting the percentage of the aperture portion occupied by the reflecting portion in the range of 15% to 50%, it is possible to display images on the reflecting portion using the projector 2 as described above, while also realizing a high sense of transparency in the liquid crystal panel 1 in the state in which an image is not displayed (when the liquid crystal layer 13 is in the light transmitting state). In other words, by setting the percentage of the reflecting portion in the above-described range, it is possible to obtain a high sense of transparency in the portion in which the liquid crystal layer 13 is in the light transmitting state, without reducing the image display quality of the liquid crystal panel 1.

### SECOND EMBODIMENT

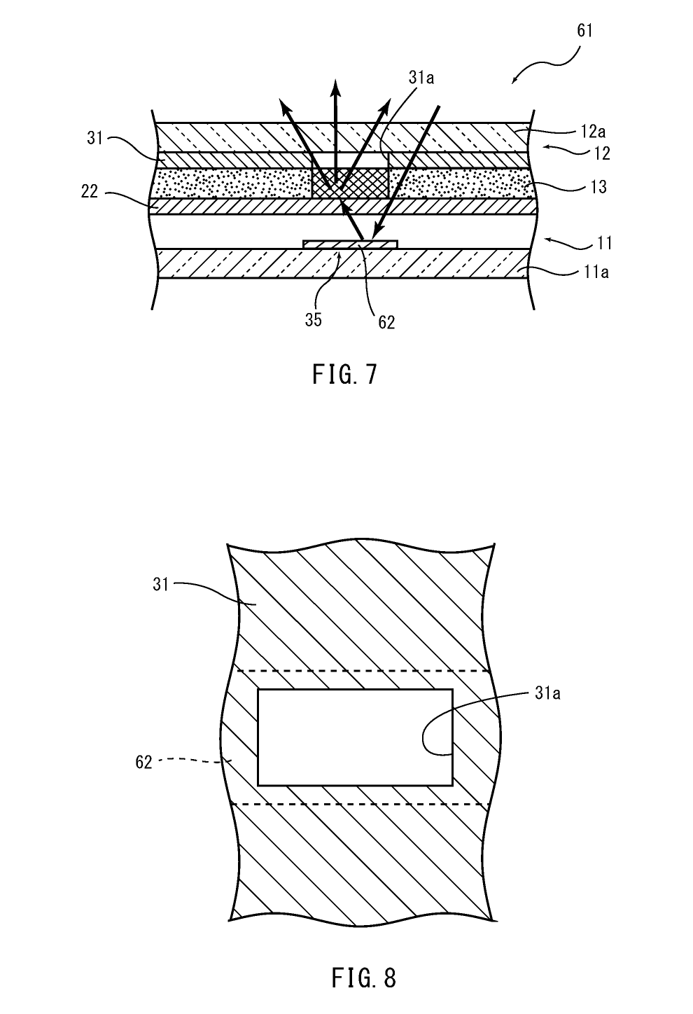

FIG. 7 shows the schematic configuration of a liquid crystal panel 61 according to a second embodiment. This embodiment differs from the above-described first embodiment in that portions corresponding to the reflecting portions 35 are cut out of the common electrode and the pixel electrodes. Portions having configurations and functions similar to those in the first embodiment will be given the same reference signs as in the first embodiment, and will not be described below. Note that configurations such as the black matrix and the TFTs have been omitted from FIG. 7, and only a simplified cross-sectional view of the liquid crystal panel is shown.

Specifically, as shown in FIG. 7, a cutout portion 31a is provided in the common electrode 31 of the counter substrate 12 in correspondence with a line 62 that is a metal portion. Since an electric field is not applied to the liquid crystal layer 13 in the cutout portion 31a, that portion of the liquid crystal layer 13 (the portion indicated by cross-hatching in FIG. 7) is always in the light scattering state. Note that the portion where the cutout portion 31a is provided is only the portion corresponding to the reflecting portion 35 (line 62).

Also, as shown in FIG. 8 as well, the cutout portion 31a is formed with a size such that it is located within the reflecting portion 35 (line 62) in a plan view. If a cutout portion that is larger than the reflecting portion 35 in a plan view is provided, the liquid crystal layer 13 will always be in the scattering state in the portion of the cutout portion that extends beyond the reflecting portion 35, thus causing a commensurate decrease in transmissivity and degradation in appearance. Accordingly, it is preferable that the cutout portion 31a is formed with a size such that it is located within the reflecting portion 35 in a plan view. Also, if the cutout portion 31a is formed so as to have the same shape as the metal portion, the common electrode 31 will be divided by the cutout portion 31a, and therefore it is preferable that the common electrode 31 remains connected in the periphery of the cutout portion 31a. Note that FIG. 8 is a plan view showing the schematic configuration of the common electrode 31. The line 62 is indicated by dashed lines in FIG. 8 in order to show an example of the positional relationship between the common electrode 31 and the line 62.

According to this configuration, it is possible to prevent reflections due to the reflecting portion 35 that is not covered by the black matrix when the liquid crystal layer 13 is in the light transmitting state. Specifically, if a cutout portion 31a such as that described above is not provided, when the liquid crystal layer 13 enters the light transmitting state, light that enters from the counter substrate 12 side (observation side) undergoes regular reflection due to the reflecting portion 35, and thus reflections appear. In contrast, by providing the cutout portion 31a as in the present embodiment and always putting the portion of the liquid crystal layer 13 that corresponds to the reflecting portion 35 in the light scattering state, reflected light from the reflecting portion 35 can be diffused as shown by the bold arrows in FIG. 7. This enables diffusing light that undergoes regular reflection due to the reflecting portion 35 and preventing reflections due to the reflecting portion 35.

Note that although the cutout portion 31a is provided in the common electrode 31 of the counter substrate 12 in the present embodiment, cutout portions may be provided in the pixel electrodes 22 of the active matrix substrate 11, and cutout portions may be provided in both the common electrode 31 and the pixel electrodes 22.

### EFFECTS OF SECOND EMBODIMENT

With this embodiment, the cutout portion 31a is provided in the common electrode 31 in correspondence with the reflecting portion 35 such that the portion of the liquid crystal layer 13 that corresponds to the metal portion (line 62) that is to serve as the reflecting portion 35 is always in the light scattering state. Accordingly, light that undergoes regular reflection due to the reflecting portion 35 is scattered by the liquid crystal layer 13, thus preventing reflections due to the reflecting portion 35. Accordingly, it is possible to prevent a reduction in the sense of transparency of the liquid crystal panel 61 caused by reflections due to the reflecting portion 35.

### THIRD EMBODIMENT

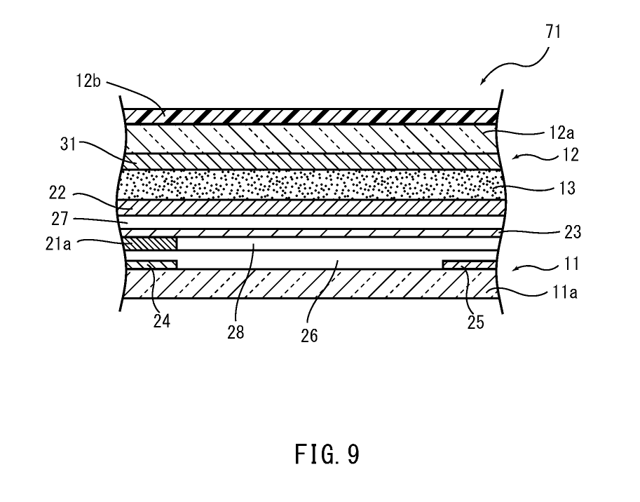

FIG. 9 shows the schematic configuration of a liquid crystal panel 71 according to a third embodiment. This embodiment differs from the above-described first embodiment in that the black matrix is not provided, and the material of the TFTs 21 is changed. Portions having configurations and functions similar to those in the first embodiment will be given the same reference signs as in the first embodiment, and will not be described below.

Specifically, the TFTs 21 (switching elements) are not configured using amorphous silicon or polycrystalline silicon, but rather are configured using an indium-gallium-zinc composite oxide (referred to hereinafter as IGZO). Since IGZO has the characteristic of transmitting light having a wavelength of 400 nm or longer, off-state leakage current is not produced by light having a wavelength of 400 nm or longer in TFTs 21 configured using IGZO. In other words, since IGZO absorbs light having a wavelength shorter than 400 nm, off-state leakage current is produced by light having a wavelength shorter than 400 nm in TFTs 21 configured using IGZO. Note that the liquid crystal itself in the liquid crystal layer 13 is also damaged by light having a wavelength shorter than 400 nm.

In view of this, similarly to a normal liquid crystal panel, a UV cutoff filter (not depicted) is provided in the present embodiment as well. Accordingly, light having a wavelength shorter than 400 nm is cut by the UV cutoff filter, thus making it possible to prevent the TFTs 21 configured using IGZO and the liquid crystal layer 13 from being irradiated with light having a wavelength shorter than 400 nm. This makes it possible to prevent the liquid crystal layer 13 from being damaged, and to suppress the production of off-state leakage current by the TFTs 21.

Configuring the TFTs 21 using IGZO in this way eliminates the need for the black matrix that shields the TFTs 21 from light in order to prevent the production of off-state leakage current. This enables a commensurate simplification of the manufacturing process, and enables an improvement in the aperture ratio. Also, since IGZO transmits visible light, a commensurate improvement in transmissivity can also be achieved. Moreover, since the black matrix that covers the metal portions such as lines is also eliminated, a commensurate improvement in reflectivity can also be achieved.

Furthermore, since the black matrix is eliminated, the entirety of the mixture obtained by mixing a macromolecule matrix, liquid crystal, and the like can be sufficiently irradiated with ultraviolet light when forming the liquid crystal layer 13. This allows suppressing the formation of very large droplets in the liquid crystal layer 13, and allows preventing a reduction in the degree of scattering. Accordingly, the above-described configuration enables suppressing a reduction in the display performance of the display panel 71.

Note that IGZO is used as the material for the TFTs in the present embodiment since it transmits light in the visible range and does not produce off-state leakage current due to light in the visible range. However, another material may be used as long as it is a material that transmits light in the visible range and does not produce off-state leakage current due to light in the visible range. The material of the TFTs in the present embodiment can be any oxide semiconductor containing any one element from among Mg, Ca, B, Al, Fe, Ru, Si, Ge, and Sn, such as ZnO (zinc oxide) or ITO (indium tin oxide).

### EFFECTS OF THIRD EMBODIMENT

In this embodiment, the black matrix is not necessary since the TFTs 21 are configured using IGZO. Accordingly, since the step for forming the black matrix is not necessary, a commensurate reduction in manufacturing cost can be achieved. Also, since the black matrix is not provided, the transmissivity and the reflectivity can be improved. Furthermore, the entirety of the mixture obtained by mixing a macromolecule matrix, liquid crystal, and the like can be sufficiently irradiated with ultraviolet light when forming the liquid crystal layer 13 composed of PNLC, thus making it possible to suppress the formation of very large droplets. This enables preventing a reduction in the display quality of the liquid crystal panel 71.

### OTHER EMBODIMENTS

Although embodiments of the present invention are described above, the above-described embodiments are merely examples for carrying out the present invention. Accordingly, the present invention is not limited to the above-described embodiments, and the above-described embodiments can be appropriately modified without departing from the gist of the invention.

In the embodiments, the liquid crystal layer 13 is configured such that the liquid crystal enters the light transmitting state when an electric field is applied. However, in the first and third embodiments, a configuration is possible in which the liquid crystal layer 13 enters the light transmitting state when an electric field is not applied, and enters the light scattering state when an electric field is applied.

In the first embodiment, the reflecting portion 35 is configured by the CS lines 25 and the portions of the source lines 23 and the gate lines 24 that are not covered by the black matrix 32. However, the reflecting portion 35 may be configured by a portion of those lines, not all of those lines. In other words, out of the CS lines and the remaining portions of the source lines 23 and the gate lines 24, a portion may be covered by the black matrix 32.

Also, lines such as the CS lines are used as the reflecting portion 35 in the embodiments. However, lines other than the source lines 23, the gate lines 24, and the CS lines 25 may be used as the reflecting portion. Examples of these lines include dummy lines.

### INDUSTRIAL APPLICABILITY

A display panel according to the present invention is applicable as a liquid crystal panel that can switch to a light transmitting state and a light scattering state depending on whether or not an electric field is applied, and on which an image is projected by a projector or the like.

1. A display panel comprising:
a liquid crystal layer that can switch to a light transmitting state and a light scattering state;
a metal layer provided in a portion of the liquid crystal layer on a side opposite to an observation side;
a line at least partially configured by the metal layer; and
a pair of transparent electrodes provided so as to sandwich the liquid crystal layer on respective sides of the liquid crystal layer,
wherein the line is provided with a reflecting portion by which at least a portion of light that entered from the observation side is reflected toward the observation side.

2. The display panel according to claim 1, further comprising:
a light-shielding layer that blocks external light,
wherein the reflecting portion has an area that, per pixel, is in a range of 15% to 50%, inclusive, of the area of a portion other than the light-shielding layer.

3. The display panel according to claim 1,
wherein a cutout portion in which the transparent electrode is not formed is provided in correspondence with the reflecting portion in at least one of the pair of transparent electrodes.

4. The display panel according to claim 3,
wherein the cutout portion is provided so as to be located within the reflecting portion when viewed from the observation side.

5. The display panel according to claim 1, further comprising:
a switching element provided on the side of the liquid crystal layer opposite to the observation side,
wherein the switching element is composed of a material that can transmit light in a visible range and does not produce stand-by consumption current due to light in the visible range.

6. The display panel according to claim 5,
wherein the liquid crystal layer contains polymer network liquid crystal.

7. The display panel according to claim 5,
wherein the switching element is configured by an indium-gallium-zinc composite oxide.

8. The display panel according to claim 1, further comprising:
a black matrix layer that defines a pixel aperture portion,
wherein the reflecting portion is configured by a portion of the line that is not covered by the black matrix layer.

9. The display panel according to claim 1, further comprising:
a reflection prevention film provided on a surface on at least one of the observation side and a back face side.

10. A display device comprising:
the display panel according to claim 1; and
a projection device that irradiates the display panel with light from the observation side.
